(19) United States
(12) Patent Application Publication
(10) Pub. No.: US 2024/0320349 A1
(43) Pub. Date: Sep. 26, 2024

(54) SYSTEMS AND METHODS FOR ROLE HARMONIZATION, APPLICATION, AND MONITORING

(71) Applicant: PATHLOCK, INC., DALLAS, TX (US)

(72) Inventors: DRIES HORIONS, DALLAS, TX (US); SUMIT SANGHA, DALLAS, TX (US)

(21) Appl. No.: 18/024,160

(22) PCT Filed: Sep. 1, 2021
(86) PCT No.: PCT/US21/48718

§ 371 Date: Aug. 21, 2023

Related U.S. Application Data
(60) Provisional application No. 63/073,406, filed on Sep. 1, 2020.

(51) Int. Cl. G06F 21/60

(52) U.S. Cl. CPC G06F 21/604; G06F 2221/2113; G06F 2221/2141

(57) ABSTRACT

A system including: at least one processor, and at least one memory having stored thereon computer program code that, when executed by the at least one processor, instructs the at least one processor to: receive one or more separation of duty (SoD) rulesets; extract user authorizations corresponding to actions that potentially violate the one or more SoD rulesets; harmonize the extracted authorizations; and identify, from the harmonized extracted authorizations, SoD violations.

### CROSS-REFERENCE TO RELATED APPLICATIONS

This application is a national stage application, filed under 35 U.S.C. § 371, of International Patent Application No. PCT/US21/4871, filed Sep. 1, 2021, which claims benefit of U.S. Provisional Application No. 63/073,406, filed Sep. 1, 2020, the entirety of which is incorporated by reference as if set forth in full below.

### FIELD

The present disclosure relates generally to relates to information technology security, and more particularly to user authorization management and role redesign within an enterprise resource planning system.

### BACKGROUND

Enterprise resource planning systems (ERPs) are widely used to track data, applications, and activity rights and access. As non-limiting examples, ERPs are used to keep track of business functions, such as finances, taxes, inventory, payroll, and planning, and to allow sharing of data across organizational units.

Businesses commonly utilize ERPs within distributed computing systems that spread computational and data storage resources across computer networks to a large number of geographically separate computing nodes and corporate functions. Such distributed computing systems expose sensitive data and networks to greater risks of loss, unauthorized modification, and unauthorized access than would exists in a more centralized computing system. These risks are mitigated, in part, by creating security profiles (e.g., roles) that specify what actions or activity tasks an assigned user is allowed to perform. One or more security profiles are then assigned to each user, usually in accordance with a user's position or job duties. To limit potential breach, certain tasks (e.g., activities) are supposed to be assigned to different users. For example, in some organizations, a same user may not be able to request a funds transfer and release the funds.

One of ordinary skill would recognize SAP produced by SAP AG, Walldorf, Germany as a widely used ERP system. In SAP, security profiles are called “roles,” and have transaction codes that describe the actions available to a given role. In SAP, organizations define Segregation of Duties Rulesets (SoDs) that state no one individual or role should have the physical and system access to control end-to-end phases of a business process or transaction (e.g., creating and adjusting an invoice, creating a vendor and initiating payments, processing inventory and posting payment authorization). This separation effectively reduces the associated risk of fraud and error.

Within an organization, different organizational systems/areas have different configurations, which may appear to present a violation of a SoD ruleset. The related art requires a system-by-system rule matrix based on specific mappings within each system. Not only is creating this matrix difficult and prone to errors, but, as an organization changes over time, these system-by-system rule matrices are exceedingly difficult to maintain accurately and consistently across an organization. Furthermore, the related art is unable to accurately detect SoD violations when a single individual has access in multiple organizational areas.

Accordingly, there is a need for improved systems and methods that may provide improved role analysis and harmonization, as well are dynamically creating system mappings to harmonize and apply SoD rules. Such improvements may improve system security, reduce processing overhead, and provide enhanced security tracking. Aspects of the present disclosure relate to these and other issues.

### SUMMARY

Briefly described, and according to an embodiment, aspects of the present disclosure generally relate to a system including: at least one processor; and at least one memory having stored thereon computer program code that, when executed by the at least one processor, instructs the at least one processor to: receive one or more separation of duty (SoD) rulesets; extract user authorizations corresponding to actions that potentially violate the one or more SoD rulesets; harmonize the extracted authorizations; and identify, from the harmonized extracted authorizations, SoD violations.

Briefly described, and according to an embodiment, aspects of the present disclosure generally relate to a method including: receiving one or more separation of duty (SoD) rulesets; extracting user authorizations corresponding to actions that potentially violate the one or more SoD rulesets from a role database; identifying one or more partial SoD violations of the one or more SoD rulesets in the user authorizations; monitoring the role database to identify one or more new user authorizations; and determining whether the one or more new user authorizations create an SOD violation with the identified one or more partial SoD violations.

Briefly described, and according to an embodiment, aspects of the present disclosure generally relate to a non-transitory computer readable medium having stored thereon computer program code for executing a method including: receiving one or more separation of duty (SoD) rulesets; extracting user authorizations corresponding to actions that potentially violate the one or more SoD rulesets from a role database; identifying one or more potential SoD violations of the one or more SoD rulesets in the user authorizations; monitoring user actions corresponding to the one or more potential SoD violations; detecting a user action of a user corresponding to a first action in a first potential SoD violation corresponding to an SOD violation; and preempting the SoD violation corresponding to the first potential SoD violation

### BRIEF DESCRIPTION OF THE FIGURES

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 illustrates an example environment in which one or more aspects of the present disclosure may be implemented.

FIG. 2 is a flowchart of a role harmonization and application method according to aspects of the present disclosure.

FIG. 3 is a flowchart of a role monitoring method according to aspects of the present disclosure.

FIG. 4 is a flowchart of a role monitoring method according to aspects of the present disclosure.

FIG. 5 is a block diagram of an illustrative computer system architecture, according to aspects of the present disclosure.

### DETAILED DESCRIPTION

Certain features of one or more example embodiments are described below with reference to one or more figures. It will be understood by one of ordinary skill that many alterations may be made to the described embodiments without departing from the scope of the present disclosure.

According to aspects of the present disclosure, there may be provided a system or method that performs role (e.g., security profile) redesign in an automated fashion.

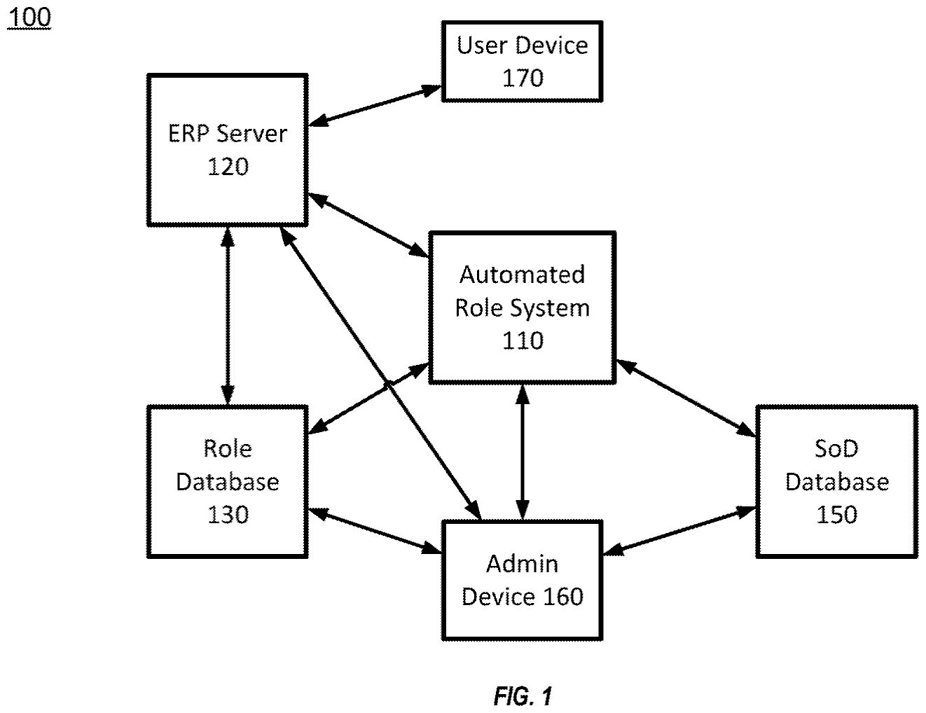

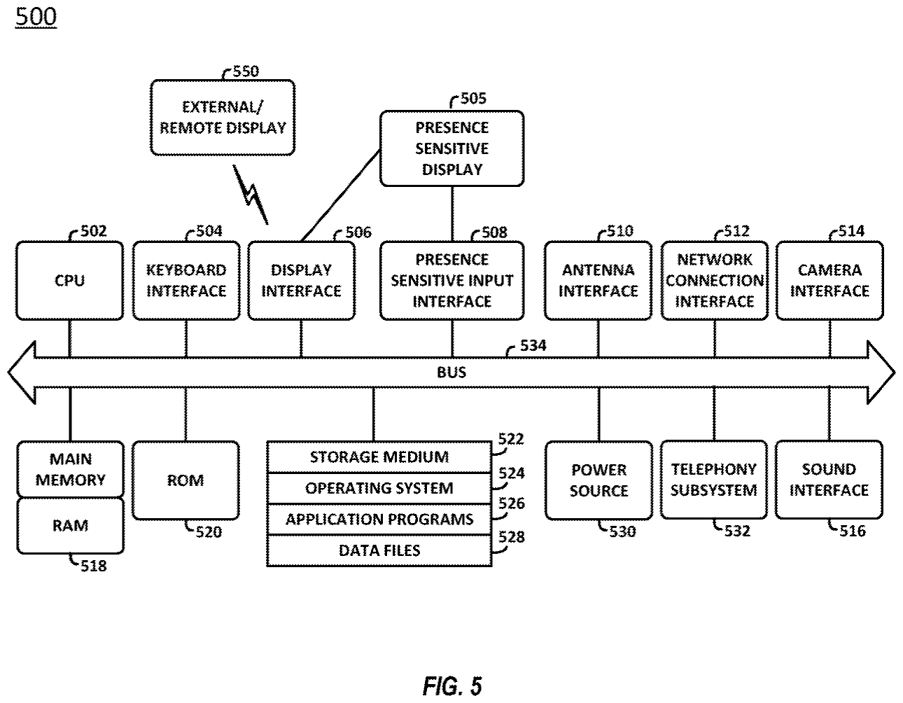

FIG. 1 illustrates an example environment 100 in which one or more aspects of the present disclosure may be implemented. The example environment includes an automated role system 110, an ERP server 120, a role database 130, an SOD database 150, admin device 160, and user device 170. One or more of automated role system 110, ERP server 120, role database 130, user activity database 140, SoD database 150, admin device 160, and user device 170 may be implemented within one or more computer system architectures, for example, as described below with reference to FIG. 5.

Automated role system 110 communicates with role database 130, SoD database 150, and admin device 160. Automated role system 110 can extract the role definitions and assignments from role database 130 for a plurality of organizational systems and SoD rulesets from SoD database 150. Automated role system 110 can harmonize the role definitions and assignments from role database 130 to determine organizational-wide user authorizations. Automated role system 110 can compare the organizational-wide user authorizations to the SoD rulesets to identify SoD violations an minimize false positives.

ERP server 120 may maintain an organization's enterprise systems. ERP server 120 may communicate with role database 130 to limit users to designated functions. For instance, a user logs-in to an organization's enterprise systems through a connection between user device 170 and ERP server 120. The ERP server 120 limits the user's access in accordance with the role assignments to the user-defined in the role database 130.

Role database 130 may include role definitions and assignments (e.g., user role assignments). In some cases, admin device 160 may provide defined roles and assignments and provide the same to role database 130. In some implementations, automated role system 110 may access and modify active roles and role assignments. In some cases, role database 130 may store legacy roles and legacy assignments, which may be reactivated or reapplied by automated role system 110.

SoD database 150 includes definitions of SoD rulesets. The SoD rulesets identify sets of duties (e.g., transaction codes or activities) that should not be performed or performable by a single user. SoD database 150 may receive the SoD rules from admin device 160 (e.g., from an administrator accessing admin device 160). SoD database 150 provides the SoD rulesets to automated role system 110 for role redesign and analysis.

Admin device 160 may be a standard or customized computing device capable of accessing or communicating with various elements of environment 100. In some cases, admin device 160 may utilize a log-in portal to adjust role descriptions and assignments in role database 130, and view or modify SoD rulesets in SoD database 150.

User device 170 may be a standard or customized computing device capable of accessing or communication with various elements of environment 100. User device 170 may interact with ERP server 120 to access enterprise systems (e.g., through a web-portal).

Although automated role system 110, ERP server 120, role database 130, SoD database 150, admin device 160, and user device 170 may be physically separate devices, this is merely an example and, in some implementations, one or more of automated role system 110, ERP server 120, role database 130, SoD database 150, admin device 160, and user device 170 may be combined within one or more physical or virtual devices. In some cases, elements and functions of one or more of automated role system 110, ERP server 120, role database 130, SoD database 150, admin device 160, and user device 170 may be combined and rearranged in one or more devices as would be understood by one of ordinary skill.

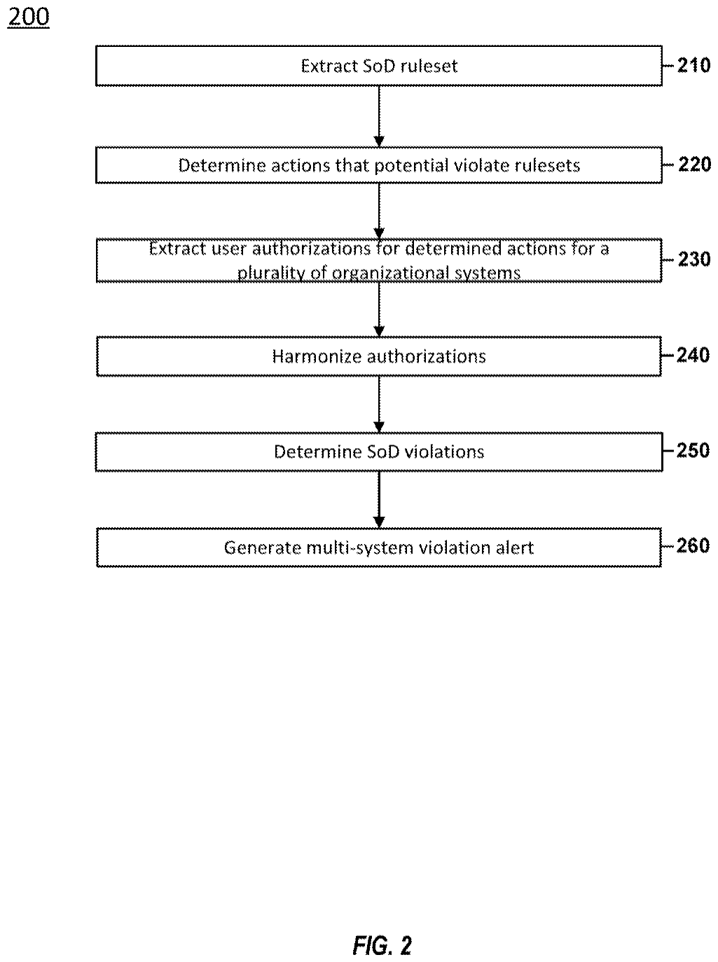

FIG. 2 is a flowchart 200 of a role harmonization and application method according to aspects of the present disclosure. As a non-limiting example, the method may be performed by automated role system 110. At 210, automated role system 110 extracts SoD rulesets from SoD database 150. The SoD rulesets, for example, identify actions that are not permissible for a single user. At 220, automated role system 110 determines actions that potentially violate the SoD ruleset based on an analysis of the SoD rulesets. At 230, automated role system 110 extracts user authorizations from role database 130 which correspond to the actions that potentially violate the SoD rulesets for a plurality of organizational systems. By extracting user authorizations based on the SoD rulesets, the overall processing requirement can be improved by eliminating analysis of authorizations that cannot result in a conflict.

At 240, automated role system 110 harmonizes the authorizations across the organizational systems. For example, automated role system 110 can identify a same vendor in multiple organization systems with divergent configurations; authorized actions for the vendor (e.g., creating an invoice and authorizing an invoice) are combined if a same user has different authorizations in different portions of the organization. Harmonizing the authorizations across organizational systems can reduce false-positive violation determinations. Harmonization can include harmonizing organizational levels and harmonizing variable values. For example, harmonization can provide for consistent analysis across organizational systems to identify sensitive activities over an overarching organization.

At 250, automated role system 110 determines SoD violations based on the harmonized authorizations. At 260, automated role system 110 can create an alert for any SOD violations across a plurality of organizational systems. Additionally or alternatively, automated role system 110 can take a corrective action, such as modifying user authorization (e.g., through admin device 160). For example, automated role system 110 can remove and/or alter a user role to correct the violation. Additionally, automated role system 110 can track the corrective action and, if the corrective action is rejected (e.g., by user device 170 and/or admin device 160), automated role system 110 can revert the corrective action.

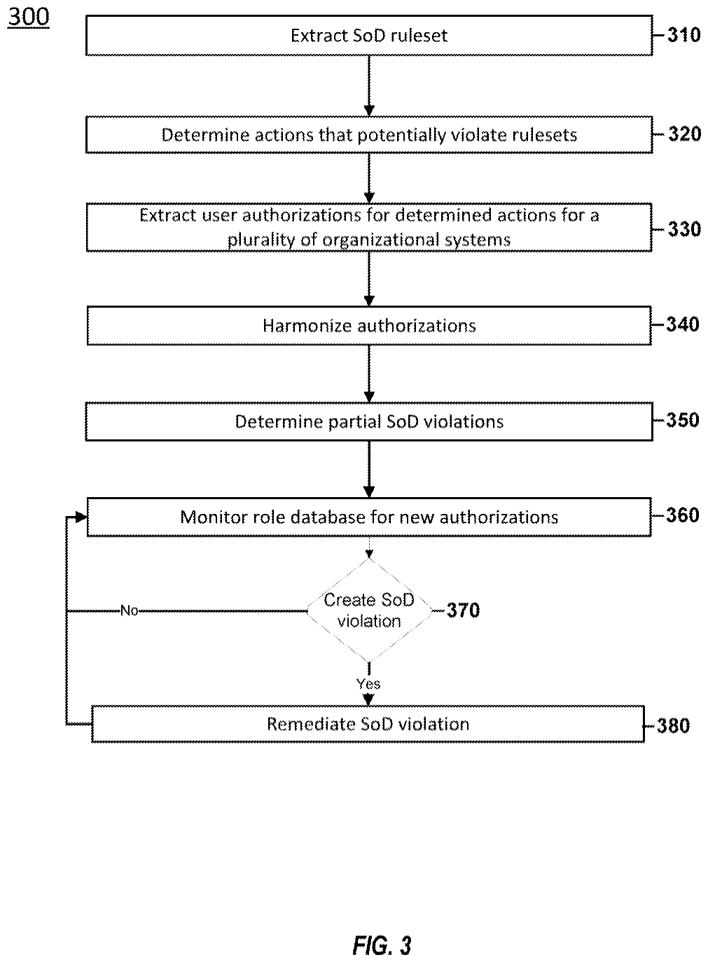

FIG. 3 is a flowchart 300 of a role monitoring method according to aspects of the present disclosure. As a non-limiting example, the method may be performed by automated role system 110. At 310, automated role system 110 extracts SoD rulesets from SoD database 150. The SoD rulesets, for example, can identify two or more actions that are not permissible for a single user. At 320, automated role system 110 determines actions that potentially violate the SoD ruleset based on an analysis of the SoD ruleset. At 330, automated role system 110 extracts user authorizations from role database 130 which correspond to the actions that potentially violate the SoD rulesets for a plurality of organizational systems. By extracting user authorizations based on the SoD rulesets, the overall processing requirement can be improved by eliminating analysis of authorizations that cannot result in a conflict.

At 330, automated role system 110 harmonizes the authorizations across the organizational systems. For example, automated role system 110 can identify a same vendor in multiple organization systems with divergent configurations; authorized actions for the vendor (e.g., creating an invoice and authorizing an invoice) are combined if a same user has different authorizations in different portions of the organization. Harmonizing the authorizations across organizational systems can reduce false-positive violation determinations and enable monitoring across organizational system.

At 350, automated role system 110 determines users with partial SoD violations based on the harmonized authorizations. A partial SoD violation can be a user authorized to perform one action of an unallowed action pair. For example, for a rule that disallows a user from creating a vendor and creating a vendor invoice, a user that is currently authorized to create a vendor would have a partial SoD violation.

At 360, automated role system 110 can monitor role database 130 to determine whether any additional roles or authorizations are applied to users with partial role violations. At 370, automated role system 110 can determine whether the additional roles or authorization now creates a SoD ruleset violation and can, at 380, remediate the SoD violation. For example, automated role system 110 can send a violation alert and/or disable the additional authorization.

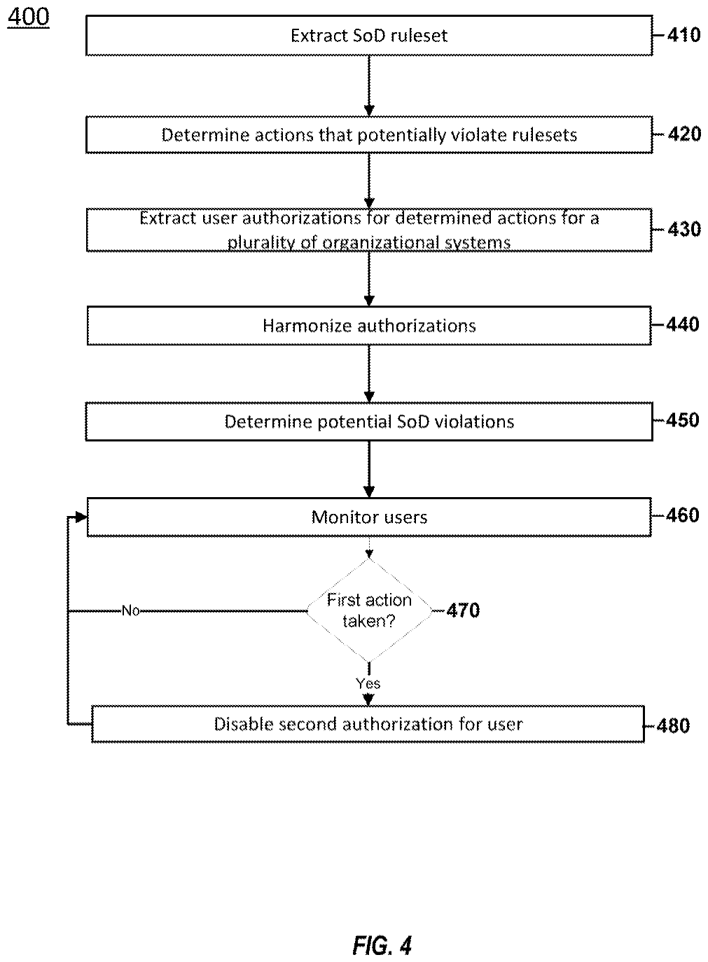

FIG. 4 is a flowchart 400 of a role monitoring method according to aspects of the present disclosure. As a non-limiting example, the method may be performed by automated role system 110. At 410, automated role system 110 extracts SoD rulesets from SoD database 150. The SoD rulesets, for example, can identify multiple actions that are not permissible for a single user. At 420, automated role system 110 determines actions that potentially violate the SoD ruleset based on an analysis of the SoD ruleset. At 430, automated role system 110 extracts user authorizations from role database 130 which correspond to the actions that potentially violate the SoD rulesets for a plurality of organizational systems. By extracting user authorizations based on the SoD rulesets, the overall processing requirement can be improved by eliminating analysis of authorizations that cannot result in a conflict.

At 440, automated role system 110 harmonizes the authorizations across the organizational systems. For example, automated role system 110 can identify a same vendor in multiple organization systems with divergent configurations; authorized actions for the vendor (e.g., creating an invoice and authorizing an invoice) are combined if a same user has different authorizations in different portions of the organization. Harmonizing the authorizations across organizational systems can reduce false-positive violation determinations and enable monitoring across organizational system.

At 450, automated role system 110 determines potential SoD violations based on the harmonized authorizations. At 460, automated role system 110 can monitor users with authorizations that can violate the SoD rulesets. Automated role system 110 can detect when an action is taken by a user and, at 470, determines whether the action is a first action in a potential SoD violation. If the action is a first action, automated role system 110 can disable the user's authorization for the second action in the potential SoD violation. For example, if a user is not allowed (based on the SoD rules) to create a vendor and generate invoices to the vendor, automated role system 110 can monitor for a user's activity for vendor creation. If a user creates a vendor, the user's authorization for generating invoices can be suspended and/or revoked.

FIG. 5 is a block diagram of an illustrative computer system architecture 500, according to an example implementation. The computer system architecture 500 may be used to implement one or more example embodiments within the scope of the present disclosure. In some cases, one or more elements of the computer system architecture 500 may be combined to embody one or more of automated role system 110, role database 130, user activity database 140, SoD database 150, admin device 160, and user device 170. It will be understood that the computing device architecture 500 is provided for example purposes only and does not limit the scope of the various implementations of the present disclosed systems, methods, and computer-readable mediums.

The computing device architecture 500 of FIG. 5 includes a central processing unit (CPU) 502, where computer instructions are processed, and a display interface 504 that acts as a communication interface and provides functions for rendering video, graphics, images, and texts on the display. In certain example implementations of the disclosed technology, the display interface 504 may be directly connected to a local display, such as a touch-screen display associated with a mobile computing device. In another example implementation, the display interface 504 may be configured for providing data, images, and other information for an external/remote display 550) that is not necessarily physically connected to the mobile computing device. For example, a desktop monitor may be used for mirroring graphics and other information that is presented on a mobile computing device. In certain example implementations, the display interface 504 may wirelessly communicate, for example, via a Wi-Fi channel or other available network connection interface 512 to the external/remote display 550.

In an example implementation, the network connection interface 512 may be configured as a communication interface and may provide functions for rendering video, graphics, images, text, other information, or any combination thereof on the display. In one example, a communication interface may include a serial port, a parallel port, a general-purpose input and output (GPIO) port, a game port, a universal serial bus (USB), a micro-USB port, a high definition multimedia (HDMI) port, a video port, an audio port, a Bluetooth port, a near-field communication (NFC) port, another like communication interface, or any combination thereof. In one example, the display interface 504 may be operatively coupled to a local display, such as a touch-screen display associated with a mobile device. In another example, the display interface 504 may be configured to provide video, graphics, images, text, other information, or any combination thereof for an external/remote display 550 that is not necessarily connected to the mobile computing device. In one example, a desktop monitor may be used for mirroring or extending graphical information that may be presented on a mobile device. In another example, the display interface 504 may wirelessly communicate, for example, via the network connection interface 512 such as a Wi-Fi transceiver to the external/remote display 550.

The computing device architecture 500 may include a keyboard interface 506 that provides a communication interface to a keyboard. In one example implementation, the computing device architecture 500 may include a presence-sensitive display interface 508 for connecting to a presence-sensitive display 507. According to certain example implementations of the disclosed technology, the presence-sensitive display interface 508 may provide a communication interface to various devices such as a pointing device, a touch screen, a depth camera, etc. which may or may not be associated with a display.

The computing device architecture 500 may be configured to use an input device via one or more of input/output interfaces (for example, the keyboard interface 506, the display interface 504, the presence sensitive display interface 508, network connection interface 512, camera interface 514, sound interface 516, etc.) to allow a user to capture information into the computing device architecture 500. The input device may include a mouse, a trackball, a directional pad, a track pad, a touch-verified track pad, a presence-sensitive track pad, a presence-sensitive display, a scroll wheel, a digital camera, a digital video camera, a web camera, a microphone, a sensor, a smartcard, and the like. Additionally, the input device may be integrated with the computing device architecture 500 or may be a separate device. For example, the input device may be an accelerometer, a magnetometer, a digital camera, a microphone, and an optical sensor.

Example implementations of the computing device architecture 500 may include an antenna interface 510 that provides a communication interface to an antenna; a network connection interface 512 that provides a communication interface to a network. As mentioned above, the display interface 504 may be in communication with the network connection interface 512, for example, to provide information for display on a remote display that is not directly connected or attached to the system. In certain implementations, a camera interface 514 is provided, which acts as a communication interface and provides functions for capturing digital images from a camera. In certain implementations, a sound interface 516 is provided as a communication interface for converting sound into electrical signals using a microphone and for converting electrical signals into sound using a speaker. According to example implementations, a random-access memory (RAM) 518 is provided, where computer instructions and data may be stored in a volatile memory device for processing by the CPU 502.

According to an example implementation, the computing device architecture 500 includes a read-only memory (ROM) 520 where invariant low-level system code or data for basic system functions such as basic input and output (I/O), startup, or reception of keystrokes from a keyboard are stored in a non-volatile memory device. According to an example implementation, the computing device architecture 500 includes a storage medium 522 or other suitable type of memory (e.g., such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 524, application programs 526 (including. for example, a web browser application, a widget or gadget engine, and or other applications, as necessary) and data files 528 are stored. According to an example implementation, the computing device architecture 500 includes a power source 530) that provides an appropriate alternating current (AC) or direct current (DC) to power components.

According to an example implementation, the computing device architecture 500 includes a telephony subsystem 532 that allows the device 500 to transmit and receive sound over a telephone network. The constituent devices and the CPU 502 communicate with each other over a bus 534.

According to an example implementation, the CPU 502 has appropriate structure to be a computer processor. In one arrangement, the CPU 502 may include more than one processing unit. The RAM 518 interfaces with the computer bus 534 to provide quick RAM storage to the CPU 502 during the execution of software programs such as the operating system application programs, and device drivers. More specifically, the CPU 502 loads computer-executable process steps from the storage medium 522 or other media into a field of the RAM 518 in order to execute software programs. Data may be stored in the RAM 518, where the data may be accessed by the computer CPU 502 during execution.

The storage medium 522 itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media allow a computing device to access computer-executable process steps, application programs and the like, stored on removable and non-removable memory media, to off-load data from the device or to upload data onto the device. A computer program product, such as one utilizing a communication system may be tangibly embodied in storage medium 522, which may include a machine-readable storage medium.

According to one example implementation, the term computing device, as used herein, may be a CPU, or conceptualized as a CPU (for example, the CPU 502 of FIG. 5). In this example implementation, the computing device (CPU) may be coupled, connected, and/or in communication with one or more peripheral devices, such as display. In another example implementation, the term computing device, as used herein, may refer to a mobile computing device such as a smart phone, tablet computer, or smart watch. In this example implementation, the computing device may output content to its local display and/or speaker(s). In another example implementation, the computing device may output content to an external display device (e.g., over Wi-Fi) such as a TV or an external computing system.

In example implementations of the disclosed technology, a computing device may include any number of hardware and/or software applications that are executed to facilitate any of the operations. In example implementations, one or more I/O interfaces may facilitate communication between the computing device and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the computing device. The one or more I/O interfaces may be used to receive or collect data and/or user instructions from a wide variety of input devices. Received data may be processed by one or more computer processors as desired in various implementations of the disclosed technology and/or stored in one or more memory devices.

One or more network interfaces may facilitate connection of the computing device inputs and outputs to one or more suitable networks and/or connections; for example, the connections that facilitate communication with any number of sensors associated with the system. The one or more network interfaces may further facilitate connection to one or more suitable networks; for example, a local area network, a wide area network, the Internet, a cellular network, a radio frequency network, a Bluetooth enabled network, a Wi-Fi enabled network, a satellite-based network any wired network, any wireless network, etc., for communication with external devices and/or systems.

According to some implementations, computer program code may be configured to control a computer device, e.g., the computer system architecture 500, to implement one or more components of one or more embodiments. According to some implementations, computer program code may be configured to control a computer device implement one or more methods within the scope of the present disclosure.

Although some example embodiments described herein have been described in language specific to computer structural features, methodological acts, and by computer readable media (e.g., non-transitory computer readable media), it is to be understood that the disclosure is not necessarily limited to the specific structures, acts or media described. Therefore, the specific structural features, acts and mediums are disclosed as example embodiments implementing the disclosure. The present disclosure is intended to cover various modifications and equivalent arrangements including those within the scope of the appended claims and their equivalents. Although specific terms are employed herein, they are used in a generic and descriptive sense only and not for purposes of limitation.

Although example embodiments of the present disclosure described herein are explained in detail, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It must also be noted that, as used in the specification and the appended claims, the singular forms “a,” “an” and “the” include plural referents unless the context clearly dictates otherwise. Moreover, titles or subtitles may be used in this specification for the convenience of a reader, which shall have no influence on the scope of the present disclosure.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

In describing example embodiments, certain terminology has been resorted to for the sake of clarity. It is intended that each term contemplates its broadest meaning as understood by those skilled in the art and includes all technical equivalents that operate in a similar manner to accomplish a similar purpose.

It is to be understood that the mention of one or more steps or blocks of a method does not preclude the presence of additional method steps or intervening method steps between those steps expressly identified. Steps of a method may be performed in a different order than those described herein. Similarly, it is also to be understood that the mention of one or more components in a device or system does not preclude the presence of additional components or intervening components between those components expressly identified.

An embodiment of the present disclosure may be implemented according to at least the following:

Clause 1: A method including: receiving one or more separation of duty (SoD) rulesets; extracting user authorizations corresponding to actions that potentially violate the one or more SoD rulesets; harmonizing the extracted authorizations; and identifying, from the harmonized extracted authorizations, SoD violations.

Clause 2: A method including: receiving one or more separation of duty (SoD) rulesets; extracting user authorizations corresponding to actions that potentially violate the one or more SoD rulesets from a role database; identifying one or more partial SoD violations of the one or more SoD rulesets in the user authorizations; monitoring the role database to identify one or more new user authorizations; and determining whether the one or more new user authorizations create an SOD violation with the identified one or more partial SoD violations.

Clause 3: A method including: receiving one or more separation of duty (SoD) rulesets; extracting user authorizations corresponding to actions that potentially violate the one or more SoD rulesets from a role database; identifying one or more potential SoD violations of the one or more SoD rulesets in the user authorizations; monitoring user actions corresponding to the one or more potential SoD violations; detecting a user action of a user corresponding to a first action in a first potential SoD violation corresponding to an SOD violation; and preempting the SoD violation corresponding to the first potential SoD violation.

Clause 4: The method of any of Clauses 1-3 further including extracting the one or more SoD rulesets from an SOD database.

Clause 5: The method of any of Clauses 1-4 further including analyze the one or more SoD rulesets to determine actions that potentially violate the one or more SoD rulesets.

Clause 6: The method of any of Clause 1-5, wherein the user authorizations potentially violate the one or more SoD rulesets for a plurality of organizational systems.

Clause 7: The method of any of Clause 1-6, wherein harmonizing the extracted authorizations includes identifying a same vendor in multiple organization systems with divergent configurations.

Clause 8: The method of any of Clause 1-7, wherein harmonizing the extracted authorizations provides for consistent analysis across a plurality of organizational systems to identify sensitive activities over an organization.

Clause 9: The method of any of Clause 1-8 further including creating an alert for any SoD violations across a plurality of organizational systems.

Clause 10: The method of any of Clause 1-9 further including taking a corrective action.

Clause 11: The method of Clause 10, wherein the corrective action includes modifying user authorization to eliminate an identified SoD violation.

Clause 12: The method of Clauses 10 or 11, wherein the corrective action includes removing a user role from a user to eliminate an identified SoD violation.

Clause 13: The method of any of Clauses 10-12, wherein the corrective action includes altering a user role to eliminate an identified SoD violation.

Clause 14: The method of any of Clauses 10-13 further including tracking the corrective action.

Clause 15: The method of any of Clauses 10-14 further including, in response to the corrective action being rejected, reverting the corrective action.

Clause 16: The method of any of Clauses 1 and 3-15, identifying one or more partial SoD violations of the one or more SoD rulesets in the user authorizations.

Clause 17: The method of Clause 16 further including monitoring the role database to identify one or more new user authorizations; and determining whether the one or more new user authorizations create an SOD violation with the identified one or more partial SoD violations.

Clause 18: The method of Clause 2 or 17 further including, in response to determining the one or more new user authorizations creates an SOD violation with the identified one or more partial SoD violations, remediating the SoD violation.

Clause 19: The method of Clause 18, wherein remediating the SoD violation includes disabling at least one of the one or more user authorizations.

Clause 20: The method of any of Clauses 2, 18, and 19, wherein a partial SoD violation is determined by an authorization of one action of an unallowed action pair in an SOD rule.

Clause 21: The method of any of Clauses 2 and 18-20, wherein the one or more new user authorizations includes an added role to a user having a partial SoD violation.

Clause 22: The method of any of Clauses 2 and 18-21, wherein the one or more new user authorizations includes an additional authorization for a user having a partial SoD violation.

Clause 23: The method of any of Clauses 1, 2, and 4-22 further including identifying one or more potential SoD violations of the one or more SoD rulesets in the user authorizations/

Clause 24: The method of Clauses 3 or 23 wherein a potential SoD violation includes a user being authorized to execute both actions of an unallowed action pair in an SOD rule.

Clause 25: The method of Clauses 23 or 24 further including monitoring user actions corresponding to the one or more potential SoD violations.

Clause 26: The method of any of Clauses 23-25 further including detecting a user action of a user corresponding to a first action in a first potential SoD violation corresponding to an SoD violation.

Clause 27: The method of any of Clauses 23-26 further including preempting the SoD violation corresponding to the first potential SoD violation.

Clause 28: The method of Clause 3 or Clause 27, wherein preempting the SoD violation includes disabling a second action in the first potential SoD violation for the user.

Clause 29: The method of any of Clauses 3, 27, and 28, wherein preempting the SoD violation includes disabling a user's authorization to conduct a second action in the first potential SoD violation.

Clause 30: A system including at least one processor; and at least one memory having stored thereon instructions that, when executed by the at least one processor, controls the at least one processor to implement the method according to any of Clauses 1-29.

Clause 31: A non-transitory computer readable medium having stored thereon computer program code for executing a method according to any of Clauses 1-29.

What is claimed is:

1. A system comprising:
at least one processor; and
at least one memory having stored thereon computer program code that, when executed by the at least one processor, instructs the at least one processor to:
receive one or more separation of duty (SoD) rulesets;
extract user authorizations corresponding to actions that potentially violate the one or more SoD rulesets;
harmonize the extracted authorizations; and
identify, from the harmonized extracted authorizations, SoD violations.

2. The system of claim 1, wherein the computer program code, when executed by the at least one processor, further instructs the at least one processor to extract the one or more SoD rulesets from an SOD database.

3. The system of claim 1, wherein the computer program code, when executed by the at least one processor, further instructs the at least one processor to analyze the one or more SoD rulesets to determine actions that potentially violate the one or more SoD rulesets.

4. The system of claim 1, wherein the user authorizations potentially violate the one or more SoD rulesets for a plurality of organizational systems.

5. The system of claim 1, wherein harmonizing the extracted authorizations comprises identifying a same vendor in multiple organization systems with divergent configurations.

6. The system of claim 1, wherein harmonizing the extracted authorizations provides for consistent analysis across a plurality of organizational systems to identify sensitive activities over an organization.

7. The system of claim 1, wherein the computer program code, when executed by the at least one processor, further instructs the at least one processor to create an alert for any SoD violations across a plurality of organizational systems.

8. The system of claim 1, wherein the computer program code, when executed by the at least one processor, further instructs the at least one processor to take a corrective action.

9. The system of claim 8, wherein the corrective action comprises modifying user authorization to eliminate an identified SoD violation.

10. The system of claim 8, wherein the corrective action comprises removing a user role from a user to eliminate an identified SoD violation.

11. The system of claim 8, wherein the corrective action comprises altering a user role to eliminate an identified SoD violation.

12. The system of claim 8, wherein the computer program code, when executed by the at least one processor, further instructs the at least one processor to:
track the corrective action; and
in response to the corrective action being rejected, reverting the corrective action.

13. A method comprising:
receiving one or more separation of duty (SoD) rulesets;
extracting user authorizations corresponding to actions that potentially violate the one or more SoD rulesets from a role database;
identifying one or more partial SoD violations of the one or more SoD rulesets in the user authorizations;
monitoring the role database to identify one or more new user authorizations; and
determining whether the one or more new user authorizations create an SOD violation with the identified one or more partial SoD violations.

14. The method of claim 13 further comprising, in response to determining the one or more new user authorizations creates an SOD violation with the identified one or more partial SoD violations, remediating the SoD violation.

15. The method of claim 14, wherein remediating the SoD violation comprises disabling at least one of the one or more user authorizations.

16. The method of claim 13, wherein a partial SoD violation is determined by an authorization of one action of an unallowed action pair in an SOD rule.

17. The method of claim 13, wherein the one or more new user authorizations comprises an added role to a user having a partial SoD violation.

18. The method of claim 13, wherein the one or more new user authorizations comprises an additional authorization for a user having a partial SoD violation.

19. A non-transitory computer readable medium having stored thereon computer program code for executing a method comprising:
receiving one or more separation of duty (SoD) rulesets;
extracting user authorizations corresponding to actions that potentially violate the one or more SoD rulesets from a role database;
identifying one or more potential SoD violations of the one or more SoD rulesets in the user authorizations;
monitoring user actions corresponding to the one or more potential SoD violations;
detecting a user action of a user corresponding to a first action in a first potential SoD violation corresponding to an SOD violation; and
preempting the SoD violation corresponding to the first potential SoD violation.

20. The non-transitory computer readable medium of claim 19, wherein preempting the SoD violation comprises disabling a second action in the first potential SoD violation for the user.

21. The non-transitory computer readable medium of claim 19, wherein preempting the SoD violation comprises disabling a user's authorization to conduct a second action in the first potential SoD violation.
